(19) United States
(12) Patent Application Publication
(10) Pub. No.: US 2022/0357458 A1
(43) Pub. Date: Nov. 10, 2022

(54) METHOD OF REDUCING LIGHT POLLUTION EFFECT, CONTROL SYSTEM AND CONTROL DEVICE

(71) Applicant: Vladimir Eliich PASHKOVSKY, St. Petersburg (RU)

(72) Inventor: Vladimir Eliich PASHKOVSKY, St. Petersburg (RU)

(21) Appl. No.: 17/420,761

(22) PCT Filed: Dec. 5, 2019
(86) PCT No.: PCT/RU2019/000896

§ 371 Date: Jul. 29, 2022

(30) Foreign Application Priority Data
Dec. 3, 2019 (RU) 2019139214

(51) Int. Cl. G01S 17/933

(52) U.S. Cl. CPC G01S 17/933

(57) ABSTRACT

The invention relates to reducing light pollution of optical instruments. A method of reducing effect of light pollution on an optical receiving device, including implementing a plurality of light sources as pulsed light sources, each pulsed light source switched on periodically with time duration tₑₘ, time period T and time shift d, based on a position of each light source relative to the optical receiving device; suppressing light flux from the pulsed light sources in the optical receiving device using a shutter, wherein at least some of the light sources are movable and the time shift d changes depending on a current position of each pulsed light source during its movement; in an area defined around the optical receiving device within a particular distance therefrom, switching on the pulsed light sources located within the area based on the time shift d being constant and defined for the area.

### BACKGROUND OF THE INVENTION

### Field of the Invention

The invention relates to a field of artificial illumination, in particular, to methods of light emission control, as well as to a field of optical receiving devices, in particular, to methods of reducing light pollution that affects optical receiving devices.

### Background of the Related Art

Outdoor illumination is one of main sources of atmosphere light pollution near cities, motorways and industrial sites. Light pollution substantially complicates operations of different optical receiving devices, in particular, optical devices such as astronomical instruments. Light pollution also affects life and labor activities of people.

Known methods of generating light fluxes, e.g., by directing outdoor illumination to particular areas do not reduce light pollution substantially, inter alia, since the light fluxes are reflected by soil, snow or water and still enter atmosphere freely.

In addition to outdoor illumination, moving objects having illumination devices also contribute light pollution a lot.

Therefore, there is a need for new methods of reducing effect of light pollution on optical receiving devices.

There is a known illumination system of international application WO2007008283, publ. on Jan. 18, 2007, which is intended for optimizing object visibility at night. The system sets a base level of lighting and adds a variable light to that base level of lighting. Timing and sequence of the base level of lighting and the variable lighting are synchronized. The system varies light by intensity, color, direction, or a combination thereof. The system includes a detector for detecting motion or noise. The system can be implemented as a fixed lighting source, a movable lighting source, or a vehicle mounted lighting source. The system improves visibility at night and reduces occurrence of accidents. The system also saves energy and enhances quality of life by reducing light pollution.

U.S. Pat. No. 9,615,066, publ. on Apr. 4, 2017, discloses a system of smart lighting and a city sensor. An IoT device for a city includes a light source, sensors comprising a camera and a microphone; a processor coupled to the light source and the sensors; and a wireless transceiver coupled to the processor. The device, in particular, minimizes light pollution by illuminating just an area in vicinity of the light source, where a person or a vehicle moves. This is provided by detecting motion near each lamppost and switching on just a few lights in the motion area, while other light sources remain switched off.

The closest prior art is a method of prevention of light pollution that affects astronomical instruments of patent RU2662907, publ. on Jul. 31, 2018. The method includes separation of operation periods of time for lighting devices and astronomical instruments. Pulsed light flux of lighting devices is generated with frequency that is not imperceptible for human vision and with a certain duty cycle, and suppressing light flux to photosensitive matrix of an astronomical instrument is provided in pulsed mode with the same frequency but in counter-phase to the generated light flux. This solution allows improving protection of astronomical instruments against light pollution. However, it does not provide protection against moving or movable light sources, as substantial change of distance between an illumination device and an astronomical instrument affects time of propagation of light pulse, which, in turn, causes loss of synchronization.

Patent RU2662907 also discloses a system for control of light sources. Synchronization of power pulses of all power sources is ensured by adjustable synchronization and delay devices. As the synchronization signal, either a periodical signal having accuracy of not less than 10 microseconds, preferably not less than 1 microsecond from a special source, or a standard time signal received via GPS, GLONASS or other publicly available system providing standard time signals may be used.

Patent RU2662907 also discloses a device for control of a shatter of a photo receiver in an astronomical instrument. The control device includes adjustable synchronization and delay devices. The synchronization signal may be either a periodic signal from a special source or a standard time signal.

### SUMMARY OF THE INVENTION

An advantageous effect of the claimed inventions is reducing effect of light pollution on at least one optical receiving device caused by fixed or movable light sources. The claimed method and system provide protection of not only stationary astronomical instruments, but also other kinds of optical receiving devices including moving or movable optical receiving devices.

A first aspect of the invention is a method of reducing effect of light pollution, which includes the following.

A method of reducing effect of light pollution on at least one optical receiving device includes that at least some of light sources provided in form of pulsed light sources causing light pollution are switched on periodically with time duration tₑₘ, time period T and time shift d, depending on position of the light sources relative to the optical receiving device. Light flux from the pulsed light sources is suppressed in the optical receiving device, and the time shift d is changed depending on current location of the pulsed light sources, when they move. At least one area is defined around the optical receiving device that is most important to be protected against light pollution at a particular distance from the optical receiving device. The pulsed light sources located within the area are switched on based on the constant time shift d, defined for this area.

The method provides reducing light pollution caused by both fixed and movable light sources, most of all, for the optical receiving device that is most important to be protected against light pollution. To do that, the light sources are provided in form of pulsed light sources, which are switched on periodically.

It means that at least one area is formed around this optical receiving device at a particular distance therefrom, where the light sources are switched on based on the constant time shift d. Depending on distance between a given area and the optical receiving device (e.g., an observatory telescope), the time shift d may vary. Therefore, the light flux from light sources that induces light pollution is suppressed, when it comes from distant defined areas, not only from the nearest defined area.

Predefining areas (at a predefined distance from the optical receiving device) with the constant time shift d for switching on the light sources allows providing protection of not only the optical receiving device that is most important to be protected against light pollution, but also all other optical receiving devices located within areas covered by this method.

This allows obtaining the claimed advantageous effect, i.e., reducing light pollution caused by both fixed and movable light sources and induced in both fixed and moving optical receiving devices located in the areas. Light pollution of the optical receiving device that is most important to be protected against light pollution may be almost eliminated. Thus, a simple and effective system for reducing effect of light pollution may be provided.

In one embodiment of the invention, current positions of light sources are determined using signals of a satellite-based navigation system.

In another embodiment of the invention, current positions of light sources are determined by receiving signals of terrestrial stations.

Additionally, operation of the pulsed light sources is synchronized by coordinated universal time signals.

Further, an area is defined, where the light sources are switched on based on the constant time shift d_{N} at a distance Z=ND, where D is equal to 30 to 70 km, and N is a sequential number of the area by distance D. In particular, light flux of the pulsed light sources is generated in form of periodical pulses having frequency of 50 to 1000 Hz and duty ratio of 1.05 to 20.

In one embodiment, the optical receiving device that is protected against light pollution is an astronomical instrument.

A second aspect of the invention is a system for providing control of light sources.

At least some of light sources provided in form of pulsed light sources in the system for control of light sources have control devices configured to periodically switch on the light sources, with time duration tₑₘ, time period T and time shift d, depending on position thereof relative to the optical receiving device that is protected against light pollution. The control devices of light sources are configured to receive synchronization signals and signals for determination of their locations.

A third aspect of the invention is a control device of optical receiving device.

The control device of optical receiving device includes a unit for receiving and processing synchronization signals and signals for determination of the optical receiving device location relative to the pulsed light sources configured to be periodically switched on, with time duration tₑₘ, time period T and time shift d, depending on position thereof relative to the optical receiving device that is protected against light pollution.

The control device includes a unit for generating signals for suppressing light flux from the pulsed light sources. Input of the unit for generating signals is connected to output of the unit for receiving and processing signals.

### DEFINITION OF TERMS

An optical receiving device is a device used for research, exploration and observation of objects in a visible light/optical spectrum, which needs to be protected against external light pollution impeding observation, in particular, against outdoor illumination.

Light sources causing light pollution are outdoor illumination devices of various kinds, outdoor light emitting advertising devices, outdoor light emitting information devices, illumination of building facades and other architectural structures, as well as other kinds of outdoor lighting.

Area at a certain distance from the optical receiving device is an area located at a distance within a predefined range of distances therefrom, where the same time shift d is applied for earlier switching on the light sources located in this area, both fixed and movable.

Additional features and advantages of the claimed solution are described in the following disclosure, as well as proved by the actual practice of the invention. These advantages and improvements can be achieved by neural networks that have been constructed and trained in accordance with the claimed method, specifically, following the disclosure, along with the accompanying claims and drawings.

### BRIEF DESCRIPTION OF THE ATTACHED DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a drawing illustrating operations of the method in an area.

FIG. 2 is a drawing illustrating different kinds of devices used as light sources and different kinds of devices used as optical receiving devices.

FIG. 3 is a block diagram of a control device of light sources mounted on movable objects.

FIG. 4 is a block diagram of a control device of fixed light sources.

FIG. 5 contains time diagrams of operation of pulsed light sources in different regions of an area and a time diagram of operation of a control device of an optical receiving device that is most important to be first protected against external light pollution.

FIG. 6 is a time diagram showing an example of duration of emission signals of light sources and light suppress signals of an optical receiving device.

FIG. 7 is a block diagram of a control device of an optical receiving device mounted on a movable object.

FIG. 8 is a block diagram of a control device of an optical receiving device mounted on a fixed object.

FIG. 9 contains time diagrams of operation of pulsed light sources in different regions of an area and time diagrams of operation of control devices of optical receiving devices located in this area.

FIG. 10 shows one of possible examples of operation of control devices of different light sources and operation of control devices of light pollution protection glasses.

### DETAILED DESCRIPTION OF EMBODIMENTS OF THE INVENTION

Reference will now be made in detail to the preferred embodiments of the present invention, examples of which are illustrated in the accompanying drawings.

The method and system for providing control of light sources to protect against light pollution ensure reducing effect of light pollution on optical receiving devices and people performing observation functions in a comparatively small area or in a large area.

The method is based on a principle of primarily protecting one main optical receiving device that is most important to be protected against light pollution. For example, such an optical receiving device may be an observatory telescope or a set of optical devices of the observatory.

Other optical receiving devices (which may constitute a plurality by kinds of the devices and by number thereof in this area or in adjacent areas) may also be protected against light pollution with the same effectiveness as the main optical receiving device or, possibly, with lower effectiveness, when they are located far from the main optical receiving device.

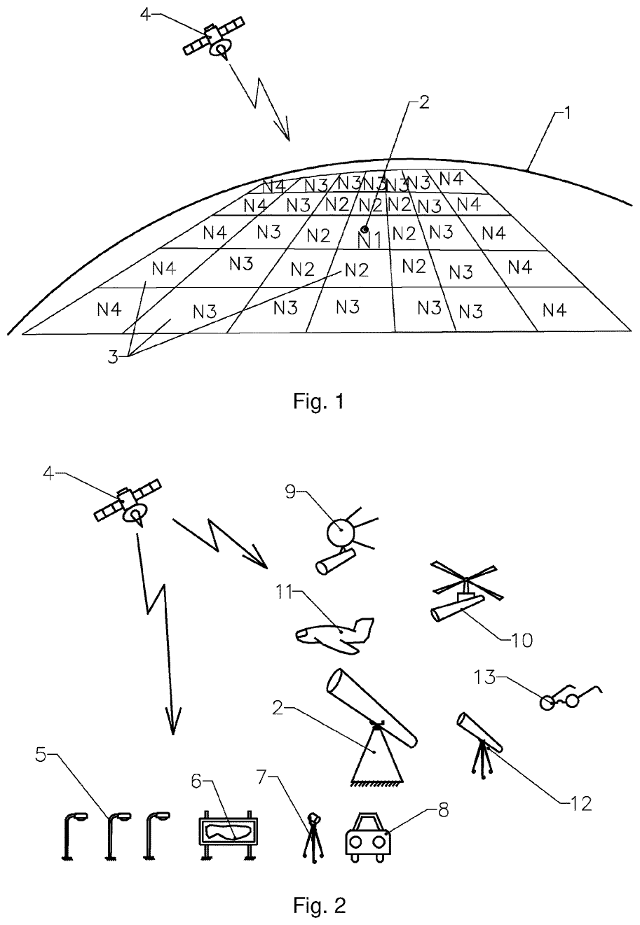

As shown in FIG. 1, area 1 of terrestrial surface around the main optical receiving device 2 is divided into regions 3 with linear dimensions of D=30 to 70 km and numbers N depending on distance Z=ND from the main optical receiving device 2. Borders of the regions (N1, N2, N3, N4) may be of any shape, not necessarily rectangular. The shape may depend on ground profile, e.g., hills, ponds, coastline, etc.

Light emitters mounted on fixed or movable objects, which cause light pollution, are equipped with light sources operating in pulsed mode and include the system for providing control of light sources.

As shown in FIG. 2, fixed light sources may be represented by outdoor lights 5, light emitting advertising facilities 6 and other light sources like lights in building (not shown). Movable light sources, which light pollution effect may also be reduced according to the method are light sources mounted on movable platforms, e.g., spotlights 7, vehicle headlights 8, etc.

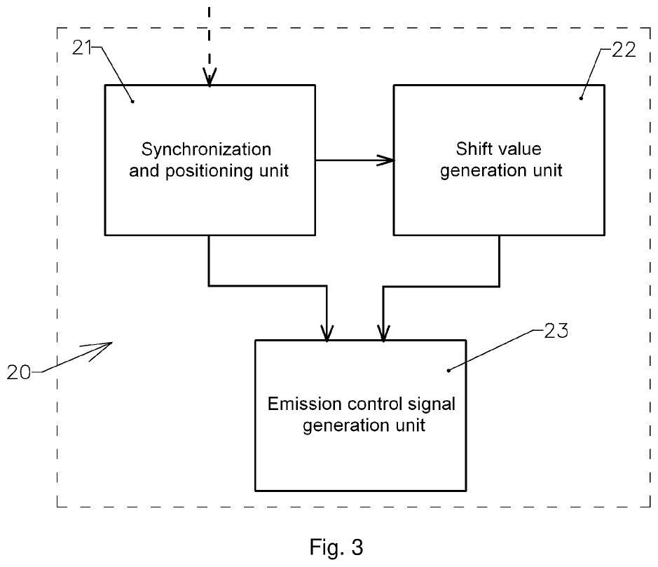

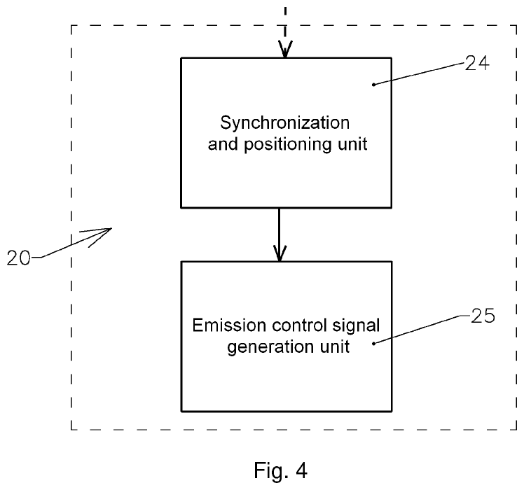

The system for providing control of light sources includes control devices configured to periodically switch on the light sources with time duration tₑₘ, time period T and time shift d, depending on position of the light sources relative to the optical receiving device that is most important to be protected against light pollution. The control devices of light sources are configured to receive synchronization signals and signals for determination of their locations. The control devices may be provided for individual light sources or for groups of light sources or for entire regions. Examples of control devices for fixed and movable light sources are shown in FIGS. 3 and 4.

The optical receiving devices shall be equipped with devices for suppressing light flux, e.g., electromechanical shutters, electronic shutters, devices for fast switching the optical receiving devices from receiving mode to idle mode, or devices for rejecting components of output electric signal formed by the light flux in the optical receiving devices.

In this context, optical receiving devices mean, in addition to astronomical optical devices, any devices receiving or passing optical radiation and having devices configured to suppress light flux or reduce light flux intensity. In particular, they include eyeglasses wearable by people, windows of buildings and other facilities equipped with illumination control systems, aircraft passenger cabin windows, aircraft crew cabin windows, etc.

For example, FIG. 2 shows some examples of optical receiving devices, in particular, fixed telescopes 2, movable (e.g., amateur) telescopes 12, satellites 9 with systems for tracking light items on the Earth, airplanes 11 with aircraft crew and passenger windows, small aircraft 10 with optical receiving systems, eyeglasses 13 of pedestrians or special glasses. This list of optical receiving devices covered by the system of this invention is not exhaustive.

Control devices of light sources and control devices of optical receiving devices operate based on standard time signals and positioning signals. These signals may be received from satellites 4 (FIGS. 1 and 2) of GLONASS system or GPS system or from terrestrial stations transmitting such signals, e.g., related to mobile communication systems. It is possible to transmit control signals by wire from a single control unit to fixed light sources, e.g., outdoor lights or light sources of a building or a group of buildings. Thus, determination of location may be performed using satellite-based positioning systems, cellular communication networks or fixed communication systems.

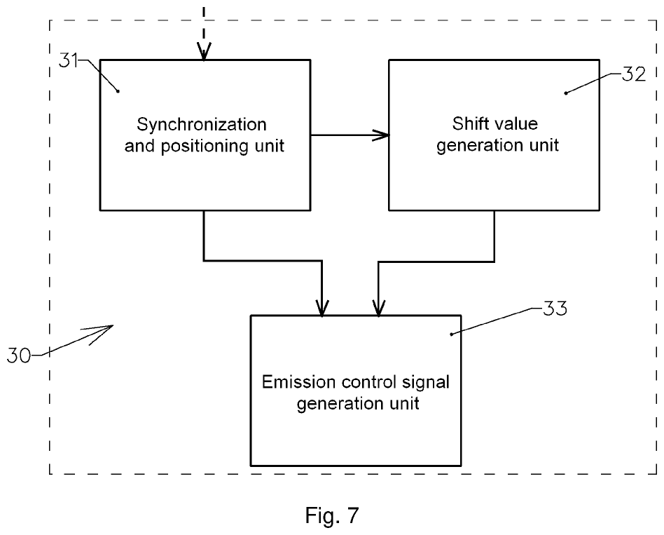

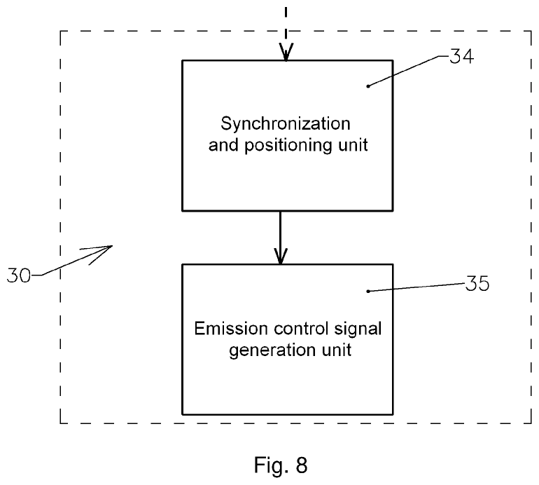

Block diagrams of control devices of light sources and control devices of optical receiving devices are shown in FIGS. 3, 4 and in FIGS. 7, 8.

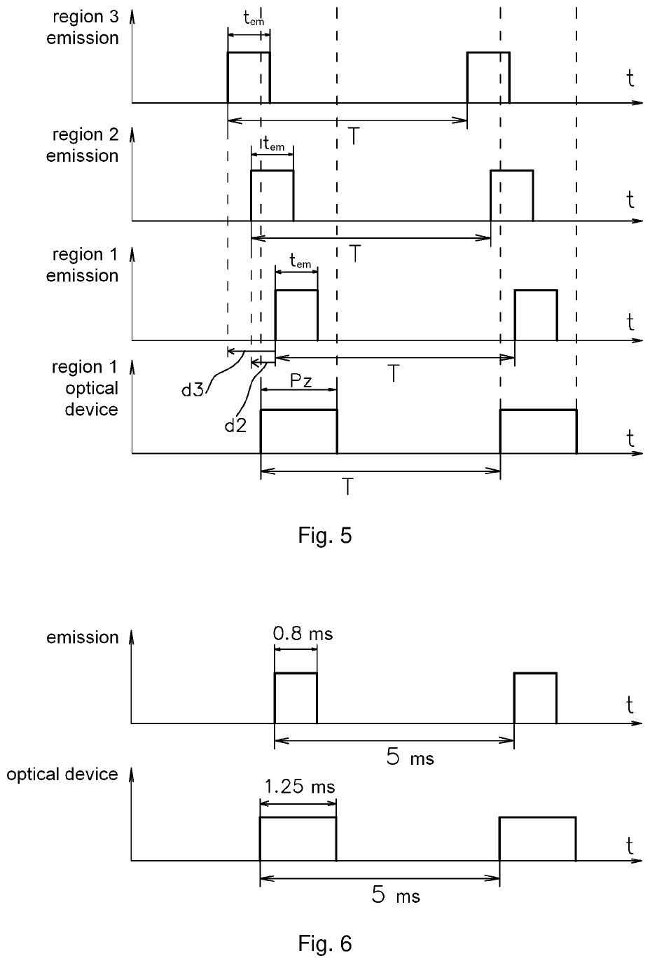

FIG. 3 shows a block diagram of a light emission control device 20 mounted on a movable object capable of moving from one region N to another region. As it was discussed in the above, such objects may include vehicles and light sources installed on movable platforms. The control device includes a synchronization and positioning unit 21 that, in particular, comprises a receiver of standard time signals and positioning signals of GLONASS or GPS positioning system. The synchronization and positioning unit 21 receives standard time and positioning signals (shown by a dashed line in the block diagram). It is connected to a shift value generation unit 22 and an emission control signal generation unit 23. The shift value generation unit 22 is configured to generate a shift signal d (time interval d), which value depends on the region where a given light source of a movable object is located. The shift value generation unit 22 is connected to the emission control signal generation unit 23. An emission start shift signal d1 is equal to zero for region N1, and is equal to d2, d3, d4 for regions N2, N3, N4. The emission control signal generation unit 23 generates an emission signal, as shown in FIG. 5.

Value d2 corresponds to time of propagation of a light pulse travelling from region N2 to region N1. With average extent of each region of 50 km, this time is about 165 μs. Value d3 corresponds to time of propagation of a light pulse travelling from region N3 to region N1. Since this distance is 100 km in average, the time is about 330 μs. Value d4 corresponds to time of propagation of a light pulse travelling from region N4 to region N1, which distance is 150 km in average, so the time is about 495 μs.

When the pulsed light source operates with the lowest frequency in the range, which is equal to 50 Hz, and with the highest duty cycle of 20, duration of the light pulse is equal to 1 ms and duration of a gap between the pulses is equal to 19 ms. This mode of operation means that the optical receiving device may be in open state for almost 19 ms. So a photosensitive array of the optical receiving device may receive light flux for a long time with no interruption. Such a long time interval allows providing observation of objects of low brightness (e.g., telescopes may survey faint stars). To ensure this operation mode, it is necessary to use light sources capable of withstanding substantial peak load, as strength of a short light pulse shall be high enough so that an average level of illumination remains sufficient despite long time periods between the pulses.

In another case, when the pulsed light source operates with frequency of 50 Hz and with the lowest duty cycle of 1.05, duration of the light pulse is equal to 19 ms and duration of a gap between the pulses is equal to 1 ms. In this mode of operation, optical receiving devices may receive payload light signals during time of 1 ms or less. This means that they are able to survey bright objects only. Since time of emission of the light sources may be of 95% of pulse period, then the light sources not configured for a high peak load may be used to maintain a sufficient average level of illumination. This allows substantially reducing cost of the illumination system.

Operation of pulsed light sources in the upper portion of the frequency range, at 5000 to 1000 Hz, facilitates better reducing adverse effect of light flicker on people.

The control device of optical receiving device includes a unit for receiving and processing synchronization signals and signals for determination of the optical receiving device location relative to the pulsed light sources. It also includes a unit for generating signals for suppressing light flux from the pulsed light sources, where input of this unit is connected to output of the unit for receiving and processing signals.

FIG. 4 shows a block diagram of the light emission control device 20 installed on a fixed object. In this case, the control device 20 includes a synchronization and positioning unit 24 connected to an emission control signal generation unit 25. The synchronization and positioning unit 24 also receives synchronization signals and, if needed, positioning signals (shown by a dashed line). Generation of a control signal for a light source installed on a movable object is performed with a predetermined value d of time shift.

The discussed configuration of the control devices 20 is just an example, and all control functions may be implemented in a single device.

FIG. 7 shows a block diagram of the control device 30 of optical receiving device installed on a movable object. The control device 30 includes a synchronization and positioning unit 31 connected to a shift value generation unit 32 for control of optical receiving device and to a light flux suppress signal generation unit 33. This unit is essential for the control device 30 of optical receiving device installed on a movable object, e.g., among those mentioned in the above (amateur telescopes 12, satellites 9, airplanes 11, small aircraft 10, eyeglasses 13 of pedestrians, etc.), so as the control device of optical receiving device would be able to adjust itself, according to light emission mode of a given region while moving from one region N to another region. The shift value generation unit 32 is connected to the light flux suppress signal generation unit 33.

FIG. 8 shows a block diagram of the control device 30 of optical receiving device installed on a fixed object. In this case, the control device 30 includes a synchronization and positioning unit 34 connected to a light flux suppression signal generation unit 35. The synchronization and positioning unit 34 also receives synchronization signals according to time and, when necessary, according to position (shown by a dashed line). Generation of a control signal for the optical receiving device installed on a fixed object is performed with predetermined value d of time shift. The method of reducing effect of light pollution is implemented as follows.

All or some of light sources of a particular region (N1, N2, N3, N4) causing light pollution of optical receiving devices are implemented as pulsed light sources, e.g., as LED-based sources, which are able to switch fast to emission mode. For each region (N1, N2, N3, N4), synchronous operation of all light sources of a particular region (N1 or N2, N3, N4) is ensured by the control devices using periodic pulses with frequency of 50 to 1000 Hz and duty cycle of 1.05 to 20, which may be unified for these regions.

As shown is FIG. 5, light flux from the mentioned light sources to the optical receiving device 2 (that is most important to be protected against light pollution) is suppressed for a time period Pz when the light flux comes (lower diagram). Switch period T of the control unit of the optical receiving device is the same as of the emitting device, but duration of Pz is longer and switch time comes earlier than period of switching on the light sources. This is necessary to exclude effect of possible time inaccuracy of the equipment. The system remains operational even if there is no an optical receiving device that is protected against light pollution in region N1 and all the optical receiving devices are equal from the protection importance point of view. In this case, location of region N1 is selected based on other considerations, e.g., territory configuration. Time diagrams of emission modes for regions N1, N2, N3 are also shown in FIG. 5.

Emission mode with time shift d2 relative to switch period T of the optical receiving device 2 located in region N1 is defined for region N2, while emission mode with time shift d3 is defined for region N3 (FIG. 5).

Time shift d2 for distance of 50 km between regions N1 and N2 is about 165 μs. This is a time of propagation for a light pulse to travel 50 km. Time shift d3 for distance between regions N1 and N3 is about 330 μs.

Defining constant time shift values d for start of emission of all light sources in each region facilitates designing and operating the system. Inaccuracy related to difference of arriving light fluxes from light sources located at different edges of a given region N is compensated by that time of suppressing light fluxes to optical receiving devices located in each region is selected to be longer than duration of the emission pulse.

An example of implementation of light sources and optical receiving devices is shown in FIG. 6. Period T for both of them is 5 ms, duration of pulses tₑₘ of the light sources is 0.8 ms, and duration Pz of suppressing light in the optical receiving devices is 1.25 ms.

Pulsed light sources installed on fixed and movable objects in region N1 periodically with period T emit light pulses with duration of tₑₘ. Standard time and positioning signals comes from GLONASS or GPS system or from terrestrial synchronization devices. These signals are fed into control units 20 (FIGS. 3 and 4), where emission control signals for region N1 are generated (FIG. 5).

Optical receiving devices, which shall be protected against light pollution in region N1, also receive time synchronization and positioning signals from GLONASS or GPS system or from terrestrial synchronization devices. Operation of light flux suppressing devices is provided by control devices 30 (FIGS. 7 and 8), where light flux suppressing signals Pz are generated with period T.

In other regions N2, N3 distant from region N1, the pulsed light sources operate also periodically with period T, but with advance time shifts d2, d3 (FIG. 5), which are in front of start point of light flux suppressing signal Pz of the main optical receiving device located in region N1. This relates to all light sources located on fixed and movable objects currently located in the corresponding region.

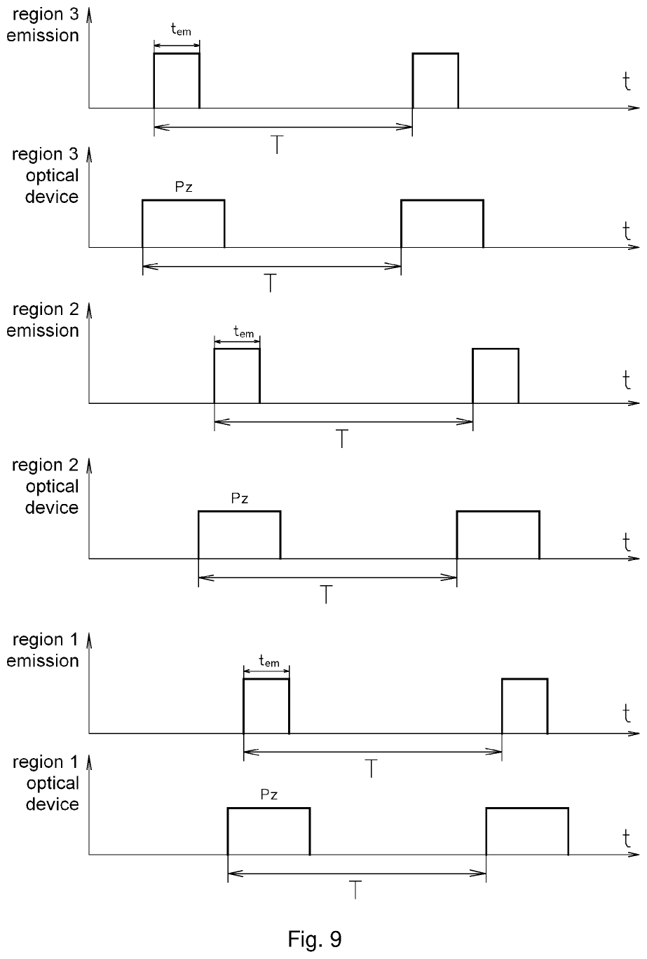

The following mode of operation is defined for optical receiving devices located in other regions N2, N3, not in region N1, which need to be protected against light pollution caused by the light sources (FIG. 9). Control devices 30 generating the light flux suppressing signal for optical receiving devices located in one of regions N2, N3 and installed on fixed or movable objects also have operation period T shifted by advance time shifts d2, d3 (FIG. 9). Light pollution caused by light sources located in regions with smaller numbers may also enter an optical receiving device. Therefore, protection against light pollution may substantially degrade. This drawback may be compensated by the following solutions: (i) defining time shift d more flexibly by dividing region N to sub-regions and/or (ii) increasing light flux suppressing interval Pz.

In some cases, e.g., to protect pedestrians against excessive light of outdoor illumination devices, outdoor advertising lights or artistic external building illumination, various algorithms may be applied for switching on light sources and activating devices for suppressing light flux in optical receiving devices.

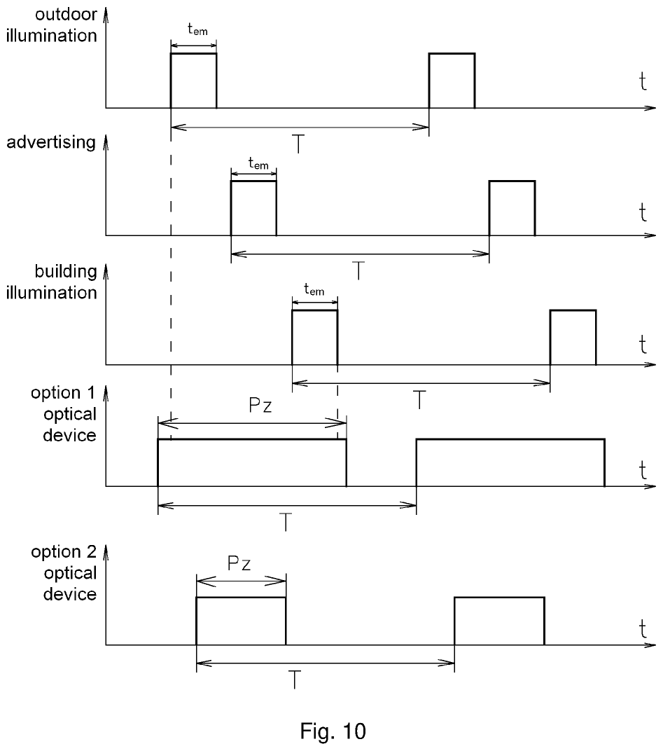

Referring to FIG. 10, emission pulses of light sources like outdoor illumination, advertising lights and external building illumination may be time shifted relative to each other. In this case, adjustment of passing light from different sources is possible by adapting start time of suppressing and duration of suppressing Pz. For example, in one option, it is possible to completely suppress light from light sources, advertising lights and external building illumination in order to see sky of stars (Option 1 in FIG. 10). In another option, it is possible to suppress part of outdoor illumination and advertising lights in order to enjoy artistic building illumination (Option 2 in FIG. 10). In other options, control of passing light may be adjusted according to any receiving option. Light control devices for light passing lens of eyeglasses may be mounted in rims. Protection against light pollution caused by various sources of illumination during photo-video- and cinema shooting may be provided in the same way.

The examples described in the above do not limit embodiments of the method.

### INDUSTRIAL APPLICABILITY

The invention may be implemented for various purposes and for protection of various optical receiving devises installed on various fixed and moving objects.

The method of reducing effect of light pollution implies that the system aimed at attaining this result is implemented around a main object like an astronomical observatory, in particular, around optical receiving devises of an observatory. In such a way of implementation, maximum effect of protection against light pollution is obtained for exactly that object. However, the system is capable of protecting multiple devices against optical pollution near the main object and in adjacent areas.

The method and system for reducing effect of light pollution caused by outdoor illumination systems of living and industrial blocks may be used for optical receiving devices located on satellites and intended for fire surveillance, in particular, regarding urban fires, and for vehicle traffic surveillance.

The method may also be used for reducing light pollution near airports to aid pilots in landing airplanes. Optical receiving devices operating in pulsed mode and suppressing light flux may be implemented in front windows of crew cabin in airplanes or in form of controllable pilot's eyeglasses.

The method may also be used for reducing light pollution near open air cinemas, in sites of performing light or laser show, in sites of displaying video projections, as well as during photo-video- and cinema shooting.

As indicated in the above, the proposed method for reducing effect of light pollution on optical receiving devises and people performing observation functions, and the control system may be implemented instantly. To do that, it is necessary simply to replace old-fashioned light sources and equip luminaries with corresponding control devices. Modification of existing optical receiving devices mainly requires introducing control devices.

Having thus described a preferred embodiment, it should be apparent to those skilled in the art that certain advantages of the described method and system have been achieved.

It should also be appreciated that various modifications, adaptations, and alternative embodiments thereof may be made within the scope and spirit of the present invention. The invention is further defined by the following claims.

1. (canceled)

2. (canceled)

3. (canceled)

4. (canceled)

5. (canceled)

6. (canceled)

7. (canceled)

8. (canceled)

9. (canceled)

10. A method of reducing effect of light pollution on an optical receiving device, comprising:
implementing a plurality of light sources as pulsed light sources, each pulsed light source switched on periodically with time duration tₑₘ, time period T and time shift d, based on a position of each light source relative to the optical receiving device;
suppressing light flux from the pulsed light sources in the optical receiving device using a shutter,
wherein at least some of the light sources are movable and the time shift d changes depending on a current position of each pulsed light source during its movement;
in an area defined around the optical receiving device within a particular distance therefrom, switching on the pulsed light sources located within the area based on the time shift d being constant and defined for the area.

11. The method of claim 10, wherein the current position is determined using signals of a satellite-based navigation system.

12. The method of claim 10, wherein the current position of the pulsed light sources is determined by receiving signals of terrestrial radio stations.

13. The method of claim 10, wherein operation of the pulsed light sources is synchronized by coordinated universal time signals.

14. The method of claim 10, wherein operation of the pulsed light sources is synchronized by signals received from a satellite.

15. The method of claim 10, wherein operation of the pulsed light sources is synchronized by signals received from a terrestrial radio station.

16. The method of claim 10, wherein operation of the pulsed light sources is synchronized by signals received via a fixed communication system.

17. The method of claim 10, wherein operation of the shutter is synchronized by coordinated universal time signals.

18. The method of claim 10, wherein operation of the shutter is synchronized by signals received from a satellite.

19. The method of claim 10, wherein operation of the shutter is synchronized by signals received from a terrestrial radio station.

20. The method of claim 10, wherein operation of the shutter is synchronized by signals received via a fixed communication system.

21. The method of claim 10, wherein the area where the pulsed light sources are switched on with the constant time shift d_{N} is defined at a distance Z=ND from the optical receiving device, where D is a distance of 30 to 70 km and N is a sequential number of the area by the distance D.

22. The method of claim 10, wherein light flux of the pulsed light sources is generated in form of periodical pulses with frequency of 50 to 1000 Hz and duty cycle of 1.05 to 20.

23. The method of claim 10, wherein the optical receiving device is an astronomical instrument.

24. A system for providing control of light sources, comprising:
a plurality of pulsed light sources, each pulsed light source including a controller that switches on periodically with time duration tₑₘ, time period T and time shift d, based on a position of each light source relative to the optical receiving device;
a shutter for suppressing light flux from the pulsed light sources in the optical receiving device,
wherein at least some of the light sources are movable and the time shift d changes depending on a current position of each pulsed light source during its movement;
in an area defined around the optical receiving device within a particular distance therefrom, the controllers switching on the pulsed light sources located within the area based on the time shift d being constant and defined for the area,
wherein the controllers are configured to receive radio synchronization signals and radio signals for determination of their locations.

25. A control device of an optical receiving device, the control device including:
a unit for receiving and processing synchronization signals and signals for determination of the optical receiving device location relative to pulsed light sources configured to be periodically switched on with a time duration tₑₘ, a time period T and a time shift d, depending on position of the light sources relative to the optical receiving device that is protected against light pollution; and
a unit for generating signals for suppressing light flux from the pulsed light sources, wherein input of the unit for generating signals is connected to output of the unit for receiving and processing synchronization signals.
